(19) United States
(12) Patent Application Publication
(10) Pub. No.: US 2005/0008204 A1
(43) Pub. Date: Jan. 13, 2005

(54) Way to avoid the accident of surgical operation of doctor and it's observable appliance

(76) Inventor: Zhang-Mu Xu, New York, NY (US)

Correspondence Address: ZHANG-MU XU, Apt. 3B, 13-15 CLINTON ST., NEW YORK, NY, 10002, US

(21) Appl. No.: 10/613,731

(22) Filed: Jul. 7, 2003

(51) Int. Cl. G06K 9/00

(52) U.S. Cl. 382/128

(57) ABSTRACT

Sometimes there might have mistakes during the surgical operation because of doctor carelessness. According the report of news paper, The accidents of surgical operation hurt patients about 1 million per year only in the U.S. and the number of death patients in surgical operation of doctor mistakes made through carelessness was about hundred thousands per year. The intention of this invention is looking for a way to protect patient from accident injury in surgical operation and to help doctor to avoid the accident happen in the surgical operation prior by observation to surgical operation, and make the appliance which is for specifically designed for use to observable to the process of surgical operation by doctor. This invention is in the field of optical device and electronic image storage device. This invention have observed that the doctor does surgical operate to patient and to record it. These theory and property are follows: By reason of a lens forms an image by using the device of video camera, then the image is transmitted by cable to the video cassette recorder and to display on the monitor for viewing and recording it. If the mistakes or the wrong operate by doctor (or operator) was happen, the observer (chief doctor or patient's relatives) only pressing the switch of another electric circuit with sounder down, the electric circuit is closed, can inform the operator by the lamp and the sounder, and to correct it immediately. So it can be avoid that the accident of surgical operation of doctor could be happen.

### THE ART FIELD

This invention is in the field of optical device and electronic image storage device. By reason of the lens forms an image. The electronic image storage device is consists of a lens of video camera video cassette recorder, and monitor. This invention is a new kind of useful of electronic image storage device.

### BACKGROUND OF THE INVENTION

The prior art of electronic observable device is widely used in the human life and industry production. In the factory, the supervisor can sit in the office to observed and to operate the process of industry production. In the bank, the manager can to see the cashier's performance by use electronic observable device and accident as well. This instrument can also used by the guarder of building to record person entrance time, if there is an accident, people could consult the tape, which is recorded by electronic observable device, to check up when, where and who is in this place, therefore to look out who is caused of accident.

In all, it concludes that the electronic observable device, which is named “The electronic image storage device”, consists of A lens of video camera, Video cassette recorder, and Monitor through a cable. They can connect a few of different products for different use. Therefore, We can making various related electronic image storage device according to specific purpose. This invention is a specifically designed for new kind of useful of electronic image storage device.

### THE INTENTION OF THIS INVENTION

When the doctor makes surgical operation. If his judgment is correct and the operation will be done according to the operational plan, it is a perfect operation. In other words, if the pain can relieve or the aggravation can be controlled, it proved that it is a successful operation.

But in fact, sometimes there might have mistakes during the operation. For example, Because of doctor carelessness, they operate the wrong body part or mistakenly cut the other normal body part. According to the report of the news paper, the accident of surgical operation hurt about 1 Million people and lead to hundred thousands people losing their lives per year only in the U.S. So the importance of this invention is that it could reduce these kinds of accidents happen, that is also the intention of this invention. The intention of this invention is to looking for a way to protect patient from accident injury in surgical operation and to help doctor to avoid the mistakes in the surgical operation by observation to surgical operation.

These theory and property are following: By reason of use the electronic image storage device. Place the lens of video camera to the above operate table nearer by operate lamp, then connect through a cable to the video cassette recorder, then to the monitor. Through electronic image storage device we can viewing and recording the all process of surgical operation, which the doctor does the operation to patient, and we can to know which part of body had been cut in the doctor's surgical operation.

Although, sometime for purpose of medical studies and research there are make a pictures of surgical operation. But this is a difference idea and intention with this invention.

The specific property of this invention are

1) The intention of this invention is to looking for the way to avoid the accident happen of surgical operation of doctor.

2) The intention of this invention is to protect patient from accident injury in the surgical operation of doctor.

3) This invention is a new specific device to observe the process of surgical operation. This invention is used by other chief doctor or patients relative to viewing and recording the process of surgical operation.

This invention will be beneficial to the following principal aspect:

1) If the doctor and operator mistakenly operate the wrong part of body in the surgical operation. This invention could be used by observer (either chief doctor or patient's relatives) to call the operator to report the mistake and to correct it immediately. Therefore it could avoid the accident happen.

2) After operation, the patients could consult records to know which inward organs of his body has been cut. Therefore, they could better understand their recovery after operation. In that case, they will feel very inward peace.

3) Through observation it could promote doctor to do operation more responsible and more best. It also could prevent the doctor cheat patient after the failure of operation.

4) If there is any accident happen. People could consult the records therefore, it is a convenient way to judge the causes of the accident.

5) Because everything is recorded during the operation, so the doctor must be very careful in surgical operation, therefore, the accident will be greatly decreased. On the other hand, the funds, used to claim compensation for failure of operation, will be greatly decreased also. In that case, the cost of responsible accident's insurance and operation expenses for the doctor could be greatly decreased. Finally, it will save the public insurance expenses of operation and health plan.

In all, the patient could increase the trust towards the hospital equipment, doctor's art and safety in operation.

### SUMMARY OF THE INVENTION

This invention is in the field of optical device and electronic image storage device. This invention have observed that the doctor does surgical operate to patient and to record it. These theory and property are follow: By reason of the lens forms an image by using the device of video camera, then the image is transmitted by cable to the video cassette recorder and to display on the monitor for viewing and to recording it.

Place a lens of video camera to the above operate table nearer by operate lamp, By reason of the lens forms an image, focus the lens of video camera and adjust the axis of lens toward to the object, that the object (which is placed on the operate table) can be viewing very clearly. Then the image can be transmitted by cable (or by wireless) to the video cassette recorder which can to receipt of it and to record of it. Then the image can be transmitted to the monitor to display on the screen of the monitor also.

There are open the all device when the surgical operation is beginning. We can viewing and recording the process of surgical operation by doctor at same time.

If the mistakes or the wrong operate by doctor was happen, the observer (chief doctor or patient's relatives) only pressing the another electric circuit switch down, the electric circuit is closed, can inform to the operator by the lamp and the sounder and to correct it immediately.

So it can be avoid that the accident of surgical operation of doctor could be happen.

### BRIEF DESCRIPTION ON THE DRAWINGS: (4 DRAWING SHEETS)

FIG. 1: The electronic image storage device consists of the lens of video camera, video cassette recorder and television, are connected by cables. It includes the Operate lamp (1), the ceiling (2), the region of lamp light (3), the lens of video camera (4), the axis of lens (5), the region of viewing from lens (6), the cable (7), the video cassette recorder (8), the video cassette tape (9), the cable (10), the television (11), the screen of television (12), the operate table (13), the object (14)

FIG. 2: The electronic image storage device consists of the lens of video camera, computer with CD-Recorder (such as CD-RW, DVD-Recordable, DVD-Rewritable) and monitor, are connected by cables. It includes: the operate lamp (1), the ceiling (2), the region of lamp light (3), the lens of video camera (4), the axis of lens (5), the region of viewing from lens (6), the cable (7), the cable (10), the operate table (13), the object (14), the CD recorder of computer (20), the CD desk (21), the monitor (22), the screen of monitor (23).

FIG. 3: The electronic image storage device consists of the lens of video camera with infrared Light emitted device, and the television with video cassette recorder, are connected by cable (or transmitter by wireless). It includes: the Operate lamp (1), the ceiling (2), the region of lamp light (3), the lens of video camera (4), the axis of lens (5), the region of viewing from lens (6), the television with video cassette recorder (11), the screen of television (12), the video cassette tape (9), the operate table (13), the object (14), the cable (or transmitter by wireless) (24).

FIG. 4: The electric circuit of sounder an alarm contained by the switch (15), red lamp (16), sounder (17), storage cell (18), and connected by cable (19).

### DETAILED DESCRIPTION OF THE INVENTION

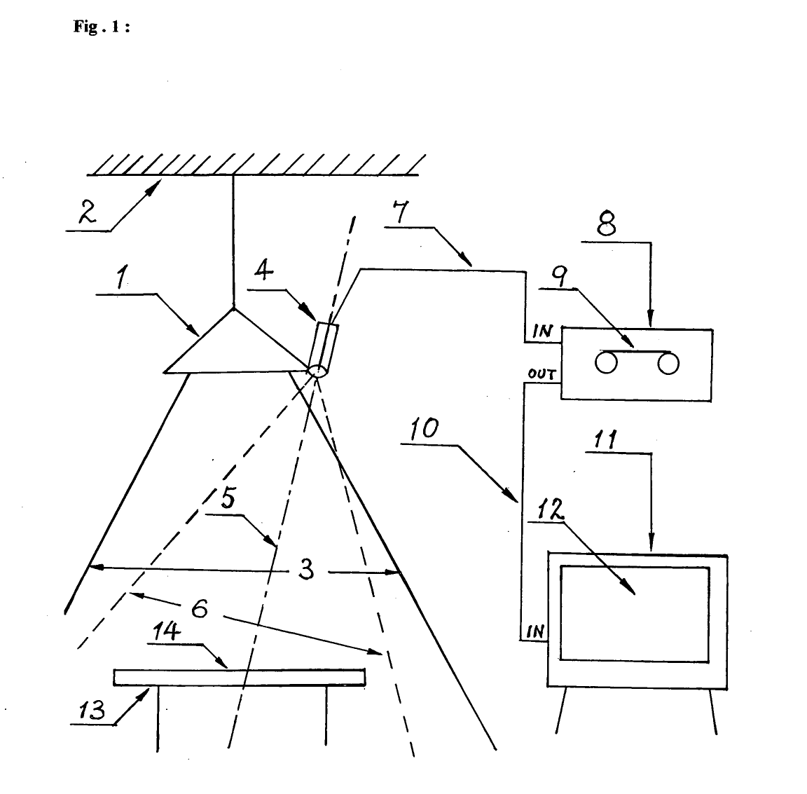

Turning generally to FIG. 1. The electronic image storage device consists of a lens of video camera, video cassette recorder and television through a cable.

To use this device, first placed the lens of video camera (4) to the above operate table (13) nearer by operate lamp (1) [or at the ceiling (2)]. Then focus the lens (4) and adjust the axis of lens (5) toward to the object (14), which is on the operate table (13), And the object (14) can be viewing very clearly by the lens of video camera (4).

The video cassette recorder (8) and the television (11) could be placed to the another observable waiting room. There are the chief doctor or patient's relative can viewing and recording it.

The cable (7) is connect with the lens of video camera (4) and the in-terminal of the video cassette recorder (8). Then the cable (10) is connect with the out-terminal of the video cassette recorder (8) and the in-terminal of the television (11) too.

But make sure the power to the all device is turned off. And the power supply is unplugged from the power source when connecting the device of the lens of video camera.

When the surgical operation by doctor is beginning. There are only push the switch of all device to turned on.

By reason of the lens forms an image by using the lens of video camera (4.) The object (14), which is the part of surgical operation on the operate table (13, forms an image by lens (4), and transmits this image through cable (7) to the video cassette recorder (8) to recording it. Then the image could be transmitted by cable (10) to the television (11) to display on the screen (12).

The observer can be viewing and recording the all process of this surgical operation.

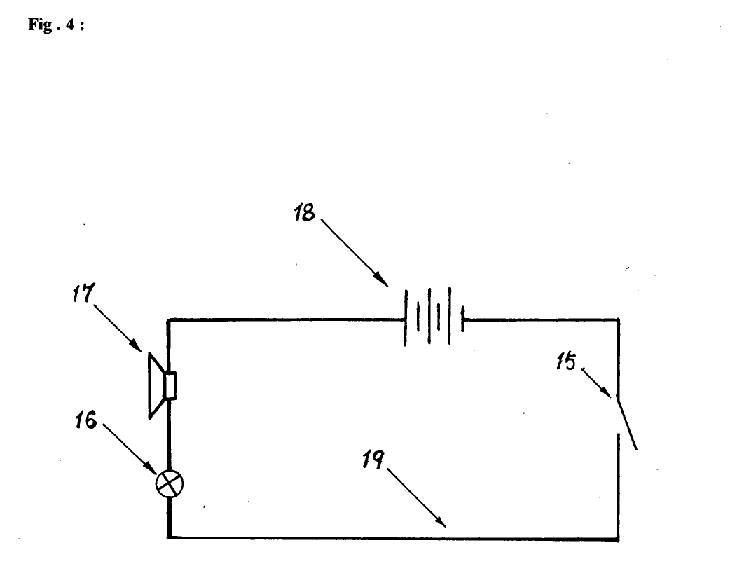

Then placed the red lamp (16) [see FIG. 4] and the sounder (17) to the operate room nearby the operate table (13). And placed the switch (15) in the observable waiting room nearby the television (11). The cable (19) is connect with the switch (15), red lamp (16, sounder (17) and the storage bell (18).

If the mistakes or the wrong operate by doctor was happen, the observer (chief doctor or patient's relatives) only pressing the switch (15) down to turned on, the electric circuit is closed, it can inform the doctor and operator by the red lamp (16) and the sounder (17), and to correct it immediately.

So it can be avoid that the accident of surgical operation of doctor could be happen.

1) This invention is a new idea and the new way, The specific property is that the intention of this invention is to help doctor to avoid the accident happen in the surgical operation.

2) This invention is a new idea and the new way, The specific property Is that the intention of this invention is to protect patient from accident injury in the surgical operation.

3) This invention is a new idea and the new way, The specific property is that for this purpose (according to claim 2 wherein said) let patient to know which inward organs of his (her) body has been cut in the surgical operation.

4) This invention is a new idea and the new way, The specific property is that for this purpose (according to claim 1 wherein said) to looking for various related methods and making various new appliances and new products, which are used for completed these new idea and the new way according to claim 1 wherein said.

5) This invention is a new product [FIG. 1] (which is one kind of the various new methods and the various new appliances and products, according to claim 4 wherein said), The specific property is that is a new use of the electronic image storage device, which consists of a lens of video camera, video cassette recorder and television through a cable, and this product is specifically designed for use as a new kind of implement to observe the surgical operate process, which the doctor does to patient, and to record it, this invention is connected with the surgical operation and the electronic image storage device.

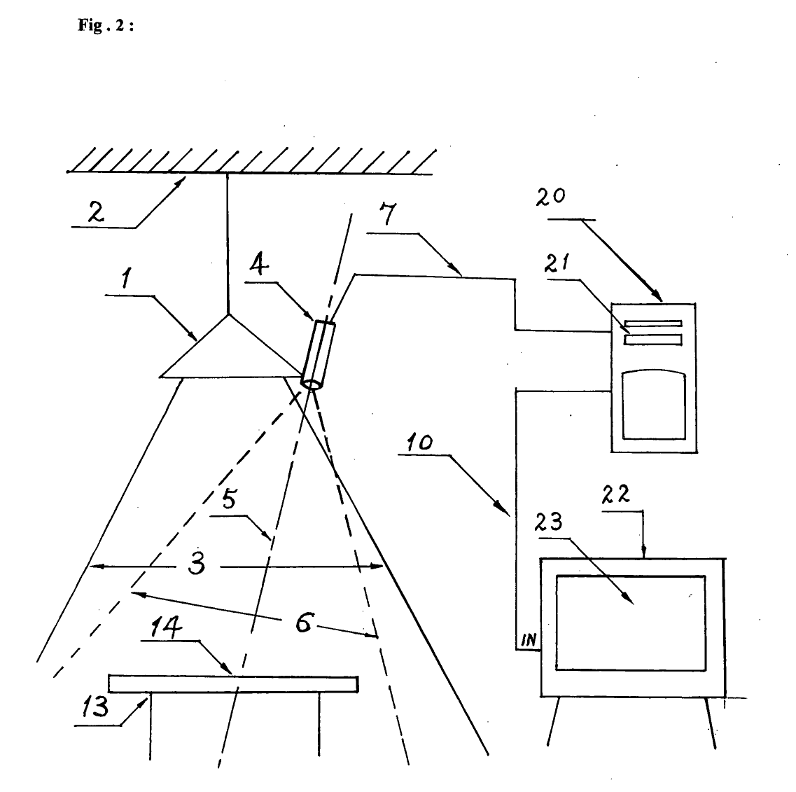

6) This invention is a new product [FIG. 2] (which is one kind of the various new methods and the various new appliances and products, according to claim 4 wherein said), The specific property is that is a new use of the electronic image storage device, which consists of a lens of video camera, computer with CD-recorder (such as CD-RW, DVD-Recordable, DVD-Rewritable, - - - ), and the monitor through a cable, and this product is specifically designed for use as a new kind of implement to observe the surgical operate process, which the doctor does to patient, and to record it.

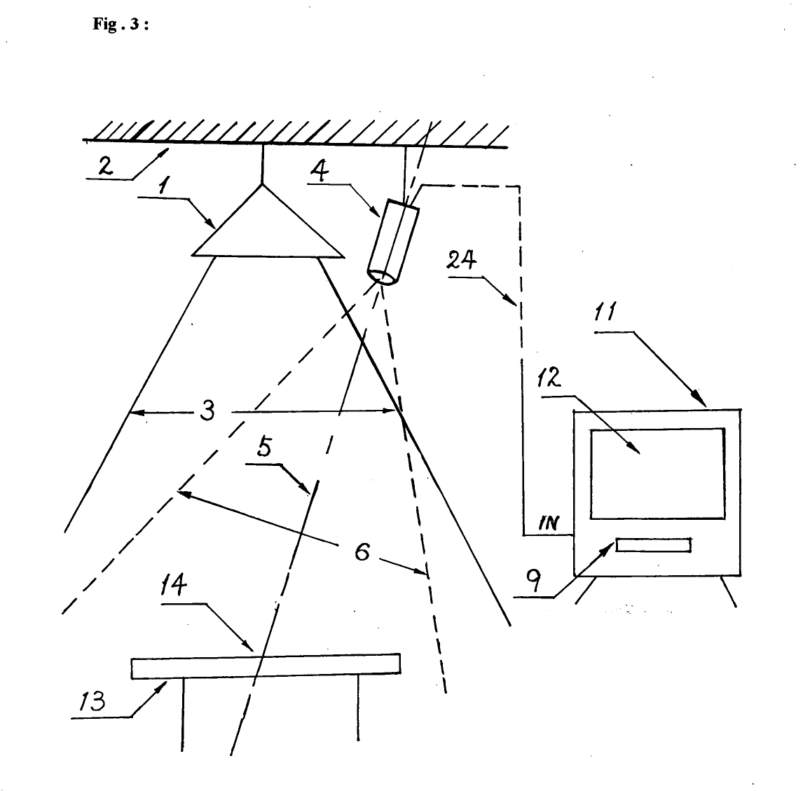

7) This invention is a new product [FIG. 3] (which is one kind of the various new methods and the various new appliances and products, according to claim 4 wherein said), The specific property is that is a new use of the electronic image storage device, which consists of a lens of video camera with infrared Light emitted device, and the television with video cassette recorder through a cable (or transmitter by wireless), this product is specifically designed for use as a new kind of implement to observe the surgical operate process, which the doctor does to patient, and to record it.

8) This invention is a part of the new product (according to claim 5 wherein said), The specific property is that is a new use of the lens of video camera, this product is specifically designed for use as a new kind of implement to observe the surgical operate process, which the doctor does to patient.

9) This invention is a part of the new product (according to claim 7 wherein said), The specific property is that is a new use of the lens of video camera with infrared Light emitted device, this product is specifically designed for use as a new kind of implement to observe the surgical operate process, which the doctor does to patient.

10) This invention is a part of the new product (according to claim 7 wherein said), The specific property is that is a new use of the other various kind of lens of video camera with any function, this product is specifically designed for use as a new kind of implement to observe the surgical operate process, which the doctor does to patient.

11) This invention is a part of the new product (according to claim 5 wherein said), The specific property is that is a new use of the various video cassette recorder, this product is specifically designed for use as a new kind of implement to observe the surgical operate process, which the doctor does to patient, and to record it.

12) This invention is a part of the new product (according to claim 5 wherein said), The specific property is that is a new use of the various video cassette tape, this product is specifically designed for use as a new kind of implement to observe the surgical operate process, which the doctor does to patient, and to record it.

13) This invention is a part of the new product (according to claim 6 wherein said), The specific property is that is a new use of the various CD-Recorder (such as the computer with CD-RW, DVD-Recordable, DVD-Rewritable, - - - ), this product is specifically designed for use as a new kind of implement to observe the surgical operate process, which the doctor does to patient, and to record it.

14) This invention is a part of the new product (according to claim 6 wherein said), The specific property is that is a new use of the CD-disk this product is specifically designed for use as a new kind of implement to observe the surgical operate process, which the doctor does to patient, and to record it.

15) This invention is a part of the new product (according to claim 6 wherein said, The specific property is that is a new use of the other various CD-disk (such as the CD-Recordable disk, The CD-Rewritable disk, - - - etc), this product is specifically designed for use as a new kind of implement to observe the surgical operate process, which the doctor does to patient, and to record it.

16) This invention is a part of the new product (according to claim 6 wherein said), The specific property is that is a new use of the other various CD-disk (such as the VCD, MP3, DVD, JPEG, Picture CD MPEG - - - etc), this product is specifically designed for use as a new kind of implement to observe the surgical operate process, which the doctor does to patient, and to record it.

17) This invention is a part of the new product (according to claim 5 wherein said), The specific property is that is a new use of the various kinds of television, this product is specifically designed for use as a new kind of implement to observe the surgical operate process, which the doctor does to patient, and to record it.

18) This invention is a part of the new product (according to claim 7 wherein said) The specific property is that is a new use of the various kinds of television with any function (such as with video cassette recorder, - - - ), this product is specifically designed for use as a new kind of implement to observe the surgical operate process, which the doctor does to patient, and to record it.

19) This invention is a part of the new product (according to claim 6 wherein said), The specific property is that is a new use of the various kinds of monitor, this product is specifically designed for use as a new kind of implement to observe the surgical operate process, which the doctor does to patient, and to record it.

20) This invention is a new product (as a new use of the electric circuit) according to claim 4 wherein said, The specific property is that is a new use of the electric circuit [FIG. 4], which is contained by the switch, lamps, sounders, cell, and the cable (and the other parts of any functions), this electric circuit is specifically designed for use as a new kind of implement to inform the doctor and surgical operator (if the mistakes or the wrong operate was happen) and to correct it immediately, so it can be avoid that the accident of surgical operation could be happen.
